(19) United States
(12) Patent Application Publication
(10) Pub. No.: US 2009/0228118 A1
(43) Pub. Date: Sep. 10, 2009

(54) METHOD FOR DISTRIBUTING SOFTWARE MODULES

(76) Inventors: Gerit Von Schwertfuehrer, Bietigheim-Bissingen (DE); Holger Niemann, Ludwigsburg (DE); Per Hagman, Alingsas (SE); Alexander Dubs, Ubstadt-Weiher (DE); Siegfried Greskamp, Weinsberg (DE)

Correspondence Address: KENYON & KENYON LLP, ONE BROADWAY, NEW YORK, NY, 10004, US

(21) Appl. No.: 12/097,562

(22) PCT Filed: Nov. 28, 2006
(86) PCT No.: PCT/EP06/68995

§ 371 Date: Nov. 12, 2008

(30) Foreign Application Priority Data
Dec. 22, 2005 (DE) 10-2005-061-393.4

(51) Int. Cl. G05B 9/00; G06N 5/02; G06F 17/00

(52) U.S. Cl. 700/21; 706/54; 701/36; 701/69

(57) ABSTRACT

A method for distributing software modules to control units, the software modules being assigned to the control units while taking safety-relevant classification features into consideration.

### FIELD OF THE INVENTION

The present invention relates to a method for distributing software modules, a device for distributing software modules, a computer program, and a computer program product.

### BACKGROUND INFORMATION

Efforts are being made to be able to freely distribute vehicle control unit software to the control units present in the vehicle. In doing so, safety aspects are to be taken into consideration in particular. In this context, completely free distribution of software modules could result in each control unit to which the software modules are to be distributed having to meet the maximum safety requirements of the software modules to be distributed. There is a risk of safety-relevant software modules being assigned to a control unit which does not meet the safety requirements of these safety-relevant software modules. It is furthermore conceivable that safety-relevant software modules cannot be distributed. This would mean a constraint on the intended software distribution.

German Patent Application No. DE 102 19 501 describes an example of interaction between software and hardware modules, taking safety-critical aspects into consideration. This document relates to a method for improving error control measures, in particular in automation systems comprising at least one standard CPU module having integrated software, at least one error-proof peripheral module, and at least one communication channel for communication between the standard CPU module and the error-proof peripheral module, the software of the standard CPU module having an operating system and a user program. When checking for errors in safety-critical data and/or checking for errors in processing safety-critical data, a combination of diversitary and encoded processing of data and/or operators is used in the standard CPU module.

### SUMMARY OF THE INVENTION

In the method according to the present invention for distributing software modules to control units, the software modules are assigned to control units taking safety-relevant classification features into consideration.

The device according to the present invention is designed for distribution of software modules to control units. It is provided that this device according to the present invention assigns software modules to the control units taking safety-relevant classification features into consideration.

The present invention also relates to a computer program having program code means for executing all steps of the method according to the present invention when this computer program is executed on a computer or an appropriate processor, in particular on a device according to the present invention.

The present invention also relates to a computer program product having program code means stored on a computer-readable data medium for executing all steps of the method according to the present invention when this computer program is executed on a computer or an appropriate processor, in particular or a device according to the present invention.

The present invention makes it possible to classify software modules and thus software to be distributed to control units. In addition, classification of control units with respect to their safety relevance or their safety requirements and consideration of these safety-relevant classification features in a process of distributing software modules or components of this software are possible. The present invention thus allows particularly targeted distribution of safety-relevant software modules to control units of a control unit group.

This makes it possible to save hardware costs in the control unit group if not every control unit is subject to the same safety requirements. After the distribution or assignment, only certain software modules may be installed on the different control units within a control unit group, for example, in a motor vehicle. Furthermore, distribution of safety-relevant software modules to control units which do not meet the safety requirements may be avoided.

In one embodiment of the present invention, initially all software mo les which are to be distributed to the control units are classified on the basis of safety-relevant classification features. The control units to which the software modules are to be distributed are also classified on the basis of the same safety-relevant classification features. The software modules and the control units are thus classified with respect to their compliance with safety requirements according to the same aspects. The classification features may be standardized according to given safety requirements.

When distributing the safety-relevant software modules, distribution of at least one software module is allowed only to a control unit that meets at least the safety-relevant classification features of the safety-relevant software modules. If such classification features are not met, no distribution may take place.

The safety integrity level (SIL) according to DIN EN 61508, which is typically classified into five levels from SIL0 to SIL4, may be used as a safety-relevant classification feature. A first software module or a first software function, for example, a fan control, may thus be assigned a SIL of 0, and a second software module or a second software function, which is formed, for example, for calculating a torque intended by the driver from an accelerator pedal position, may be as assigned a SIL of 3.

A first control unit without hardware redundancy and a safety concept may only receive software modules of level SIL0, while a second control unit having hardware redundancy, for example two processors, and equipped with a safety concept, may receive software up to level SIL3.

In this example, the second software function would have to be distributed to the second control unit. The first software function would be able to be assigned to either control unit. Since the first control unit has no redundancy or safety concept, it is less expensive than the second control unit.

The distribution may take place automatically; however, it may also be performed manually, and may be implemented within the distributed software included in the software modules and provided for control units in motor vehicles.

It is understood that the above-named features to be elucidated below N are usable not only in the given combination, but also in other combinations or by themselves without leaving the scope of the present invention.

### BRIEF DESCRIPTION OF THE DRAWINGS

FIG. 1 schematically shows an exemplary embodiment for distributing software modules to control units.

### DETAILED DESCRIPTION

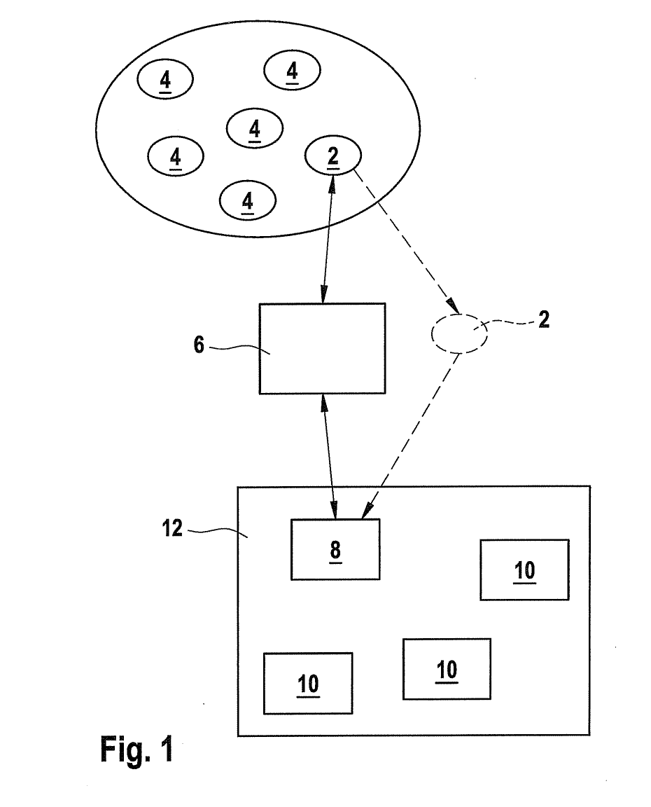

FIG. 1 schematically shows a plurality of software modules 2, 4, a device 6, and a plurality of control units 8, 10 within a control unit group 12, for example, in a motor vehicle or an electromechanical device.

It is provided that software modules 2, 4 are to be distributed to control units 8, 10 while taking safety requirements into consideration. It is to be taken into consideration that no software module 2,4 is to be assigned to a control unit 8, 10 that does not meet its safety requirements.

Device 6 is designed for assigning software modules 2, 4 to control units 8, 10 while taking safety-relevant classification features into consideration. For this purpose, software modules 2, 4 and control units 8, 10 are classified by device 6 and subdivided on the basis of the classification features. Safety integration levels are used for this purpose as classification features. Device 6 checks which classification features are met by each control unit 8, 10, so that appropriate software modules 2, 4 are assigned to this control unit 8, 10 as a function of the classification features met.

In this exemplary embodiment, a first software module 2 and a first control unit 8 are classified by device 6 and thus checked for fulfillment of the safety-relevant classification features. The safety integrity level divided into a plurality of safety-relevant classes or levels is used here as the criterion. In this case first control unit 8 meets the safety requirements of first software module 2, since the safety integrity level of first control unit 8 is at least as high as the safety integrity level of software module 2. First software module 2 is therefore assigned to first control unit 8 and installed on this first control unit 8. The present invention allows free distribution of software modules 2, 4 and thus vehicle control unit software to control units 8, 10 present in the vehicle. Safety aspects may be taken into consideration in particular. In the case of completely free distribution of software modules 2, 4, it is therefore no longer require that each control unit 8, 10 to which software modules 2, 4 are to be distribute meet the maximum safety requirements of software modules 2, 4 to be distributed. There is also no longer a risk of safety-relevant software modules 2, 4 being assigned to a control unit 8, 10 which does not meet the safety requirements of these safety-relevant software modules 2, 4. Software modules 2, 4 may now be distributed in a targeted manner, while taking the safety-relevant classification features into consideration.

1-12. (canceled)

13. A method for distributing software modules having different safety requirements to control units which differ regarding fulfillment of the safety requirements, the method comprising:
assigning the software modules to the control units taking safety-relevant classification features into consideration.

14. The method according to claim 13, wherein the software modules are classified and are subdivided on the basis of the classification features.

15. The method according to claim 13, wherein the control units are classified and are subdivided on the basis of the classification features.

16. The method according to claim 13, further comprising performing a check to determine which classification features are met by each control unit so that at least one software module is assigned to this control unit as a function of the classification features met.

17. The method according to claim 13, wherein safety integrity levels are used as the classification features.

18. The method according to claim 13, wherein the method is performed for control units of a vehicle, wherein the control units with the aid of the software modules implement functions of the vehicle, including a control of a fan or a calculation of a torque intended by a driver from an accelerator pedal position.

19. A device for distributing software modules to control units, comprising:
an arrangement for assigning the software modules to the control units taking safety-relevant classification features into consideration.

20. The device according to claim 19, further comprising an arrangement for classifying software modules and subdividing them on the basis of the classification features.

21. The device according to claim 19, further comprising an arrangement for classifying the control units and subdividing them on the basic of the classification features.

22. The device according to claim 19, further comprising an arrangement for checking which classification features are met by a control unit and for assigning at least one software module to the control unit as a function of the classification features met.

23. A computer-readable medium containing a computer program which when executed by a processor performs the following method for distributing software modules having different safety requirements to control units which differ regarding fulfillment of the safety requirements:
assigning the software modules to the control units taking safety-relevant classification features into consideration.
